(19) United States
(12) Patent Application Publication
(10) Pub. No.: US 2024/0353260 A1
(43) Pub. Date: Oct. 24, 2024

(54) AUTOMATED FMEA SYSTEM FOR CUSTOMER SERVICE

(71) Applicant: PPG Industries Ohio, Inc., Cleveland, OH (US)

(72) Inventors: Mark David Lewis, North Ridgeville, OH (US); Angela Kathleen Staufer, Berea, OH (US)

(73) Assignee: PPG Industries Ohio, Inc., Cleveland, OH (US)

(21) Appl. No.: 18/683,519

(22) PCT Filed: Jul. 12, 2022
(86) PCT No.: PCT/US2022/073617

§ 371 Date: Feb. 14, 2024

Related U.S. Application Data
(60) Provisional application No. 63/234,061, filed on Aug. 17, 2021.

(51) Int. Cl. G01J 3/46; G06Q 30/015

(52) U.S. Cl. CPC G01J 3/463; G06Q 30/015

(57) ABSTRACT

Techniques for providing feedback to match coatings. A coating system receives coating attributes of a test coating previously applied to an asset. The coating attributes include a digital measurement of the test coating and data describing environmental conditions. The system displays. on a user interface. a first surface coated using the target coating and displays a second surface coated using the test coating. The user interface also displays the coating attributes of the test coating. The system evaluates deltas observed between the test coating and the target coating. The system provides feedback to the remote facility. The feedback details the observed deltas and further provides instructions on how to reduce those deltas. By reducing the deltas. the test coating will more closely alignment with the target coating.

### CROSS-REFERENCE TO RELATED APPLICATIONS

This application claims priority to U.S. Provisional Application Ser. No. 63/234,061, filed on Aug. 17, 2021 and entitled “AUTOMATED FMEA SYSTEM FOR CUSTOMER SERVICE,” the entirety of which is incorporated herein by reference.

### BACKGROUND OF THE INVENTION

### 1. Technical Field

The present invention relates to devices, computer-implemented methods, and systems for providing feedback on matched coatings through a graphical user interface.

### 2. Background and Relevant Art

Modern coatings provide several beneficial functions in industry and society. Coatings can protect a coated material from corrosion, such as rust. Coatings can also provide an aesthetic function by providing a particular color and/or texture to an object. For example, most automobiles are coated using paints and various other coatings in order to protect the metal body of the automobile from the elements and also to provide aesthetic visual effects.

In view of the wide-ranging uses for different coatings, it is often necessary to identify a target coating composition. For instance, it might be necessary to identify a target coating composition on an asset that has sustained damage (e.g., has been in an accident). However, due to the nature of complex mixtures within coatings, it is sometimes difficult to formulate, identify, and/or search for acceptable matching formulations and/or pigmentations. Even in the case where a suitable match can be identified, frequently the coating on the asset will have aged or denatured in such a way that recoating the damaged portion with the original coating still creates a mismatch in color upon later inspection.

In general, paint manufacturers develop a large range of coatings with different colors, color variations, color effects, and the like, whether for the original automotive companies, or independently, such as to refinish assets painted with coatings from another manufacturer. The sheer volume and range of colors and coatings developed by paint manufacturers frequently provides a suitable overall color match with most damaged assets where basic color comparison on a display screen is the only consideration. Close inspection after application, however, frequently reveals small deviations in the colors that may not be apparent to the repair operator (e.g., auto-body operator), relevant front office manager, or the asset owner when looking at a color chip or computer display screen during the coating determination process.

For example, there may be differences owing to the color or physical characteristics of the underbody coating, or other effect pigments. Along these lines, flake, metallic, or other gonioapparent pigments added to the formulation can provide a mixed paint with a completely different overall color effect in certain lighting conditions than the same mixture of tint and base paint without the effect pigment. Moreover, while some coatings historically require multiple layers or added ingredients to achieve a particular effect, a new version of the coating may be made using a different technology that allows for the same visible effect but with fewer ingredients.

These differences in cost and makeup of coatings of certain colors that at first glance appear to be identical can create significant challenges for operators at an auto-body shop, and even for the asset owners. In general, there may be mismatches due to false positives. For example, a paint facility operator may select a closest match color based on the appearance on a display screen or paint chip that, on application, has a very different appearance in person. In other cases, there are no matches at all in the database, and the only appropriate solution may be a custom tint. Even in those cases, a custom tint derived through a graphical user interface may suffer from display screen characteristic deviations, again resulting in a potential mismatch upon final application. Such outcomes are present even with coating manufacturers that offer a wide range of paints, shades, and hues.

Previously, when comparing coatings, users had to ship panels back and forth in order to compare potential color matches. Such processes were highly time consuming. Additionally, some existing techniques failed to generate enough data to enable users to provide feedback on color selection or alignment. For instance, some existing tools do not fully describe a color in perceptual space. Furthermore, some existing techniques rely on non-effect flake pigmentations, which provide only limited amounts of information. Thus, there are many opportunities for new methods and systems that better enable comparison and alignment between different coatings.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

The present invention extends to systems, computer program products, and methods for providing feedback to match coatings. For example, a method can include determining that a target coating applied to a first asset has been analyzed at a remote facility. As a result of the analysis of the target coating, one or more coatings that are determined to match the target coating are also identified. The method can also include determining that a test coating has been applied to a second asset at the remote facility.

The method further includes receiving coating attributes of the test coating, which has been applied to a second asset at the remote facility. The test coating was selected from among the one or more coatings, and the coating attributes include a digital measurement of the test coating and further include data describing environmental conditions that occurred at a time when the test coating was applied to the second asset. On a user interface, the method includes displaying a first surface that is coated using the target coating and displaying a second surface that is coated using the test coating. The user interface further displays the coating attributes of the test coating. The method also includes evaluating deltas observed between the test coating and the target coating and providing feedback to the remote facility. The feedback details the observed deltas and further provides instructions on how to reduce the deltas to result in a closer alignment between the test coating and the target coating

An additional or alternative method for providing feedback to match coatings can include receiving coating attributes of a test coating previously applied to an asset. The coating attributes can include a digital measurement of the test coating and data describing environmental conditions that occurred at a time when the test coating was applied to the asset. The method further includes displaying, on a user interface, a first surface that is coated using a target coating and displaying a second surface that is coated using the test coating. The user interface further displays the coating attributes of the test coating. Deltas that are observed between the test coating and the target coating are evaluated. Feedback is then provided to a remote facility. The feedback details the observed deltas and further provides instructions on how to reduce the deltas to result in a closer alignment between the test coating and the target coating.

A computer system can be configured to provide feedback to match coatings and can include one or more processors and one or more computer-readable hardware storage devices that store instructions that are executable by the one or more processors to cause the computer system to perform various operations. For instance, the computer system can receive coating attributes of a test coating previously applied to an asset. The coating attributes include a digital measurement of the test coating and data describing environmental conditions that occurred at a time when the test coating was applied to the asset. The system displays (e.g., on a user interface) a first surface that is coated using a target coating and displays a second surface that is coated using the test coating. The user interface further displays the coating attributes of the test coating. The system evaluates deltas observed between the test coating and the target coating. The system also provides feedback to a remote facility. The feedback details the observed deltas and further provides instructions on how to reduce the deltas to result in a closer alignment between the test coating and the target coating.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example of a target coating that was previously applied to an asset, such as a vehicle.

FIG. 2 illustrates a test coating applied to an asset, where the test coating is a best fit match to the target coating.

FIG. 3 illustrates an example architecture that is configured to identify a best fit representation of a coating, such as perhaps a target coating.

FIGS. 4A and 4B illustrate an architecture that can be used to adjust coating attributes and to provide feedback on those adjustments to enable remote facilities to align test coatings with a target coating.

FIG. 5 illustrates an example user interface that enables a user to apply adjustments to the test coating in an effort to align it more closely with the target coating.

FIG. 6 illustrates a flowchart of an example method for providing feedback to match coatings.

### DETAILED DESCRIPTION

The present invention extends to computerized systems and methods for providing feedback in order to match coatings. The disclosed techniques can beneficially visualize images and color data to identify potential failure modes or misalignments between coatings. The techniques also improve the speed by which misalignments are identified and resolved, such as by refraining from having to conduct panel shipments back and forth between locations. For example, a coating analysis computer system can determine that a target coating applied to a first asset has been analyzed at a remote facility, such as a local autobody shop. As a result of the analysis of the target coating, one or more coatings (e.g., “best fit coatings”) that are determined to match the target coating are also identified. The system can also determine that a test coating has been applied to a second asset at the remote facility. The test coating was selected from among the one or more coatings.

After the test coating has been applied to the second asset, the system receives coating attributes of the test coating. The coating attributes include a digital measurement of the test coating and data describing environmental conditions that occurred at a time when the test coating was applied to the second asset. A first surface is displayed on a user interface. This first surface is coated using the target coating. The user interface also displays a second surface that is coated using the test coating and displays the coating attributes of the test coating. Deltas between the test coating and the target coating are observed and evaluated. Feedback is then provided to the remote facility. This feedback details the observed deltas and further provides instructions on how to reduce the deltas. By reducing the deltas, the test coating will be more closely aligned with the target coating.

### Examples Of Technical Benefits, Improvements, And Practical Applications

The following section outlines some example improvements and practical applications provided by the disclosed embodiments. It will be appreciated, however, that these are just examples only and that the embodiments are not limited to only these improvements.

The disclosed systems and methods bring about numerous real and practical benefits to the technical field. For instance, the systems significantly improve how users are able to provide feedback with regard to ensuring coatings align with one another. By “more closely align” or “more closely match,” it is meant that adjusted coating attributes (as a result of the adjustments) become closer in value to the coating attributes of a target value (e.g., closer as compared to their original comparative state). For instance, suppose the coating attributes of a test coating initially align with the target coating 95% (e.g., the two coatings' attributes align 95% relative to one another). To be “more closely aligned,” the attributes of the test coating can be adjusted, thereby potentially bringing those attributes to be within about 97% to that of the target coating's attributes. Accordingly, adjustments can be made in an effort to cause a test coating to more closely resemble or represent a target coating. The systems also provide an aesthetic and intuitive user interface designed to help with the feedback process.

In this regard, the present invention can provide a number of benefits to end users, such as operators of an asset repair facility (e.g., autobody shop), front office workers managing a bidding system, or even asset owners looking to select an appropriate color at minimal cost. Such benefits can include improved and more efficient color matching used to refinish an asset, such as by enabling better, more realistic matching, and interactive display of colors. Moreover, end users such as asset repair operators and even the end customer can gain confidence that a custom color designed through a graphical user interface will appear as expected on the finished product and will be consistent with the existing coating on that product. The benefits can further include improved and more efficient pricing and estimation of asset refinish projects with accurately selected colors, thereby avoiding costly mistakes that necessitate further repair and repainting. One will appreciate that such efficiencies can have large, positive impacts on the environment through waste mitigation, such as by, at least in part, minimizing the amount of materials needed for any particular project.

By following the disclosed principles, the systems and methods also enable improved use of a computer system. That is, instead of relying on traditional techniques for estimating or guessing a best fit match, the systems are designed to facilitate improved and quicker identification of a best fit match and improved alignment between coating attributes. By providing such benefits, less back-and-forth operations will be performed.

Along these lines, one can appreciate how the disclosed techniques facilitate a failure modes and effects analysis (FMEA) process. Generally, FEMA refers to an iterative process in which possible deficiencies are identified, and those deficiencies are then resolved. In the example scenarios presented herein, the FMEA process is followed by first identifying attributes of a target coating, selecting a test coating that particularly or supposedly best matches or aligns with that target coating, and then iteratively modifying the test coating until a determination is made that the adjusted test coating sufficiently matches with the target coating. By following the disclosed principles, which follow FMEA processes, an end user can have confidence that the resulting (potentially adjusted) test coating accurately aligns with the target coating, thereby providing a high level of customer service and satisfaction.

Additionally, the present invention beneficially provides various visualizations that can be used as communication tools to troubleshoot a digital auditing and color matching process. The disclosed tools can perform these processes without having to ship panels back and forth. Additionally, the present invention is able to show visualized images of physical grid matches, measured colors, and adjusted or formulated colors. In some cases, the disclosed techniques can also display colors based on rendering prediction capability of the display screens. Additionally, the disclosed systems can be equipped with CIELab graphs and other visualization tools to provide options for adjusting tinting parameters and other coating attributes of coatings to achieve a desired color, such as one that matches a target coating. The disclosed systems can also be used to increase the confidence in best color match selection by displaying a match relative to the target coating in color space and to visually display the information in a single display.

While a few technical benefits have been explicitly pointed out for the sake of example, one will appreciate that additional technical benefits may be provided according to the present invention. It is also worthwhile to note how the articles “a” or “an” can include “one or more.” That is, although the invention has been described in terms of ‘a’ feature, ‘an’ clement, and the like, one or more of any of these components or other recited components can be used according to the present invention.

### Identifying Best Matches

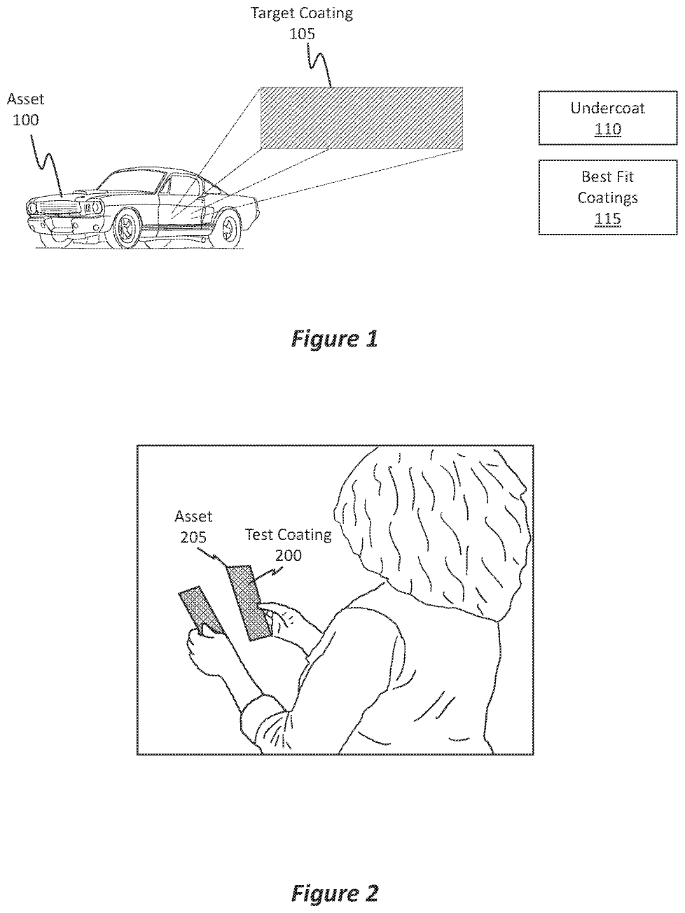

Attention will now be directed to FIG. 1, which illustrates an example of an asset 100 in the form of a vehicle. The asset 100 has been coated with a target coating 105. In some cases, an undercoat 110 has been applied to the asset 100 as well. In any event, it is often desirable to identify that target coating 105, or at least to identify a best fit match for the coating 105, as shown by best fit coatings 115 (aka best potential match). For example, it may be the case that the vehicle was involved in an accident and taken to an autobody shop (i.e. a “remote facility”). The owner of the vehicle may want the shop to paint the wrecked areas of the vehicle with the same coating as the other areas to maintain consistency across the vehicle. To do so, the shop will be tasked with identifying that target coating 105.

A coating identification computer system can be used to obtain or generate spectrometric data of the target coating 105. The spectrometric data may be gathered by a camera, a spectrometer, such as spectrophotometer, or any other device capable of scanning the target coating 105 and providing characterization data relating to attributes of the target coating 105. The spectrometric data can comprise spectrophotometric data, spectrocolorimetric data, data acquired via image processing, and/or any other similar data. The coating identification computer system can process the spectrometric data through a probabilistic colorant analysis. The probabilistic colorant analysis identifies a set of colorants that are likely present in the coating and associates with each colorant a probability that the colorant is present in the target coating 105.

As used herein, colorants include absorption and scattering pigments, effect pigments, and any other related coating or coating component. The identified set of colorants is then beneficially fed into a formulation engine (optionally in decreasing order of calculated probability of the colorant being present in the target coating 105) until one or more formulation matches (i.e. best fit coatings 115) are identified. The present invention can generate accurate, reproducible results using this approach in a matter of seconds or less, thereby resulting in significant improvements to the field. The best fit coatings 115 can be selected from a database of coatings, where that database tracks and maintains the coating attributes for any number of coatings.

In this sense, the disclosed coating identification computer systems can analytically identify potential colorants within the target coating 105. As used herein, “potential colorants” are colorants that are identified by a probabilistic colorant analysis as likely being in the target coating 105. The potential colorants are fed into a formulation or analysis engine that is seeded with colorants that have already been identified as having a high probability of being present within the target coating 105.

Any number of best fit coatings 115 can be identified using the system. Often, coatings included in the best fit coatings 115 can be ranked based on how closely they correspond, align, or match with the target coating 105. In response to identifying the best fit coatings 115, a skilled user is able to review the coatings and make a selection regarding which coating he/she thinks most closely aligns with the target coating 105. Of course, multiple coatings can be selected. For brevity purposes, the remaining disclosure will focus on the selection of a single best fit coating.

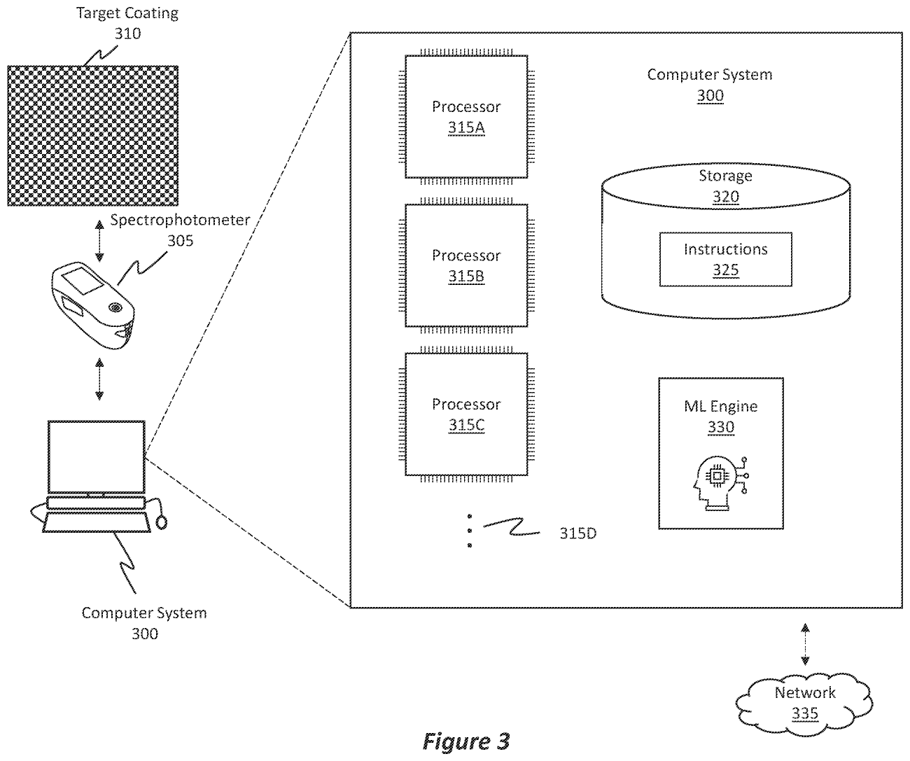

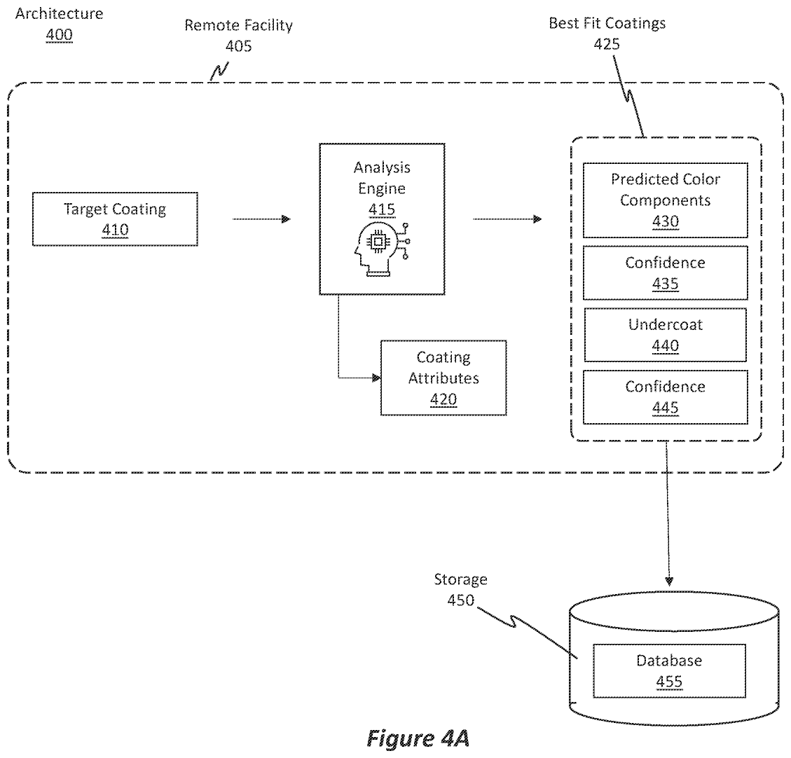

The selected best fit coating can be referred to as a “test coating.” That is, the test coating is a coating that is selected from among the one or more best fit coatings. FIG. 2 shows how a test coating 200 can then be applied to another asset 205 at the remote facility. This asset 205 can be a test surface used for application purposes in order to gauge how a selected coating is applied and cured. In some cases, the asset 205 can also be the asset 100. Once the test coating 200 cures, it can be analyzed using the techniques mentioned earlier, which techniques will be more fully described with relation to FIG. 3. In any event, the test coating 200 can then be compared against the target coating 105 to determine whether a true alignment exists between those two coatings. If the test coating 200 is not satisfactorily aligned with the target coating 105, then one or more adjustments to the coating attributes of the test coating 200 can be performed in an attempt to bring the test coating 200 into a matched state relative to the target coating 105. As will be described in more detail later, such adjustments can be adjustments to the chemical composition of the test coating 200, adjustments to a chemistry component or colorant of the test coating 200 so as to generate predicted CIELab color space values, adjustments to environmental conditions at the remote facility, adjustments to application techniques used to apply the test coating 200. adjustments to curing techniques, and many other types of adjustments.

Attention will now be directed to FIG. 3, which illustrates an example computer system 300 designed to provide improved processes for identifying a best fit match to a target coating. The computer system 300 is able to communicate with a spectrophotometer 305 to acquire initial information (e.g., the color information described earlier, such as information about pigments) about a target coating 310, which is representative of the target coating 105 from FIG. 1. In some cases, the computer system 300 can visually display a selected number of coatings that potentially match with the target coating. A user can review these so-called “best fit coatings” and can select one for further testing and analysis, such as by applying it to an asset and then obtaining coating attributes for the applied coating, as was described earlier.

As shown, the computer system 300 includes one or more processors, such as processor 315A, processor 315B, and processor 315C. The ellipsis 315D illustrates how any number of processors may be used. The computer system 300 also includes one or more computer-readable hardware storage devices, such as storage 320. The storage 320 includes instructions 325 that are executable by the processors (e.g., 315A, 315B, and/or 315C) to configure the computer system 300 to perform any number of operations, some of which will be discussed momentarily. In some cases, the computer system 300 also includes or has access to a machine learning (ML) engine 330 that is able to be trained to perform specialized operations, such as coating identification. The computer system is also able to communicate with remote devices via the network 335 (e.g., the Internet).

Any type of ML algorithm, model, machine learning, or neural network may be used to identify coatings. As used herein, reference to “machine learning” or to a ML model or to a “neural network” may include any type of machine learning algorithm or device, neural network (e.g., convolutional neural network(s), multilayer neural network(s), recursive neural network(s), deep neural network(s), dynamic neural network(s), etc.), decision tree model(s) (e.g., decision trees, random forests, and gradient boosted trees), linear regression model(s) or logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations. Further details on attributes of the computer system will be provided later. Such machine learning can be used in order to attempt to identify or determine coating attributes of any coating, whether it is a target coating or a test coating. The machine learning can also be used to predict coating attributes, such as colorimetric and/or spectral values for a particular coating.

The spectrophotometer 305 can be used to identify coating attributes (e.g., colorimeter data and/or reflectance characteristics, which can then be used to infer color attributes) for both the target coating 105 and the test coating 200 (after being applied to an asset). As an example, the coating attributes can include color formula component information, which can be inferred based on the reflectance data obtained by the spectrophotometer 305. A mapping or prediction process is available to correlate reflectance with known color formula information. The color formula component information can include various information on pigments (e.g., XIRALLIC, gonioapparent pigment, metallic flake, mica, pearlescent pigments, and the like), multiple coating layer information (e.g., tricoat, XIRALLIC), various physical or raw data measured for each coating sub-component, such as spectral, colorimetric, or other data for various tints, base coats, and effect pigments, including such data as measured from various combinations of such sub-components. The coating attributes can include predicted spectral or colorimetric data for given formulas where actual measurements have not yet been performed.

As indicated above, the coating attributes can include raw physical measurements or predicted measurements, such as spectral, or other colorimetric measurements including but not limited to CIELab (i.e., L*a*b*) values, spectrophotometer reads, RGB, and gamma-RGB values, and/or XYZ tristimulus data, etc. for each coating, and each coating sub-component. In some cases, the coating attributes include data detailing a mixture of raw physical measurements for a number of coatings and coating sub-components, and predicted physical measurements for other coatings or coating sub-components based on measurements taken from adjacent colors, such as colors in the same color space, but perhaps differing by one or more sub-components (e.g., different base), or differing by slight changes in hue, chroma, or toner ratio. In some cases, the coating attributes can also include barcode, VIN, or QR code data.

The coating information can also include information detailing how a coating was applied to an asset. For instance, the information can include which tools were used, which operators or technicians performed the application, how the coating cured, under what environmental conditions the coating was applied and allowed to cure, and so on. That is, the coating information can also include environmental data detailing the environmental conditions that existed at a time when a coating was applied and allowed to cure. Such environment data can include temperature, atmospheric pressure, elevation, humidity, time of day, season of the year, and so forth. Accordingly, the computer system 300 is able to obtain data related to any aspect of the coating process (and curing process) and can also obtain data detailing specific attributes of the coating.

### Example Architecture

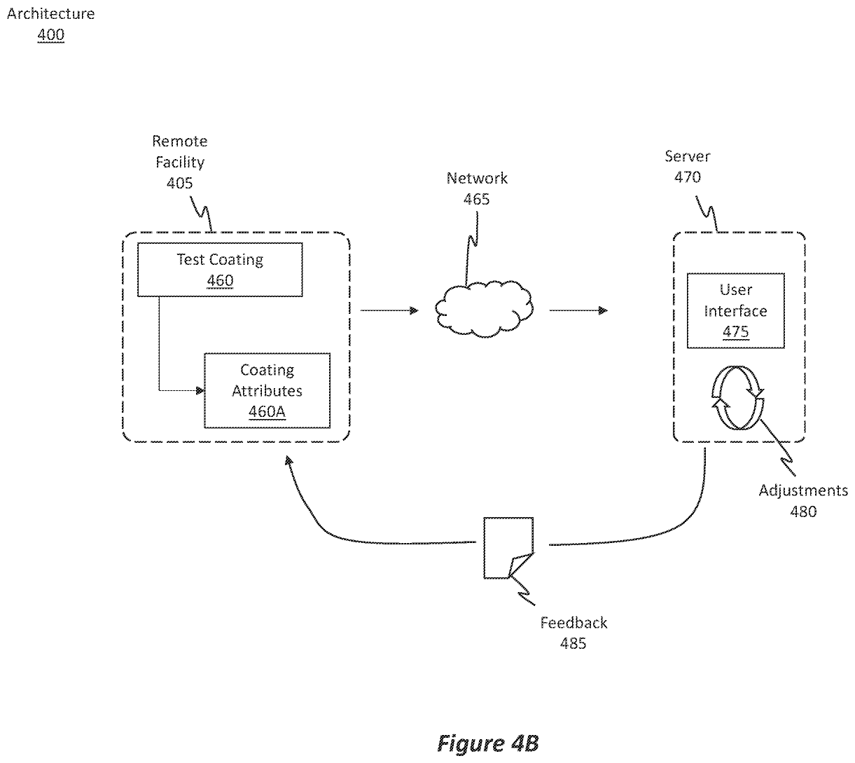

FIGS. 4A and 4B show an example architecture 400 in which the principles disclosed herein can be practiced. For instance, the architecture 400 can include a remote facility 405, such as an autobody shop. In this remote facility, a target coating 410 is available for analysis, where the target coating 410 was previously applied to an asset (e.g., perhaps at the remote facility or perhaps at a prior instance in time). For instance, a car in need of repair can be stationed at the remote facility 405, and that car may be coated with the target coating 410.

The remote facility 405 can include an analysis engine 415, perhaps in the form of the computer system 300 of FIG. 3. This analysis engine 415 is able to analyze the target coating 410 and determine coating attributes 420 (e.g., any of the attributes mentioned earlier, such as CIELab data, environmental data, and so forth) of that target coating 410. Additionally, the analysis engine 415 is able to identify one or more best bit coatings 425 that supposedly match the target coating 410.

As an example, each best fit coating that is included among the best fit coatings 425 can have certain data or coating attributes associated with it. To illustrate, FIG. 4A shows how the analysis engine 415 is able to determine various predicted color components 430 (e.g., CIELab color space values, chemistry components, tint aspects, etc.) as well as a confidence 435 metric indicating how confident the analysis engine 415 is that a particular best fit coating matches or aligns with the target coating 410 based on a comparison between coating attributes. To be “best fit,” the coating attributes (or simply “attributes”) of a particular coating are required to be within a threshold value of the attributes of the target coating 410.

That is, in order to be considered a “best fit match,” the respective parameters of a best fit coating are within a threshold value to corresponding parameters identified for the target coating 410. For instance, suppose the actual red color value of the target coating 410 was “x.” A threshold can be set so that if a potential best fit coating's red value was within plus or minus the threshold value of the target coating's red value, then the potential best fit coating would be included among the list of potential best fit coatings 425.

In some cases, the threshold value can be set to 0.1%, 0.5%, 1%, 2%, 3%, 4%, 5%, 10% or more than 10% of the actual value (or any value therebetween), whatever that value might be. Similar thresholds can be set for the other attributes.

One value for a particular attribute might exceed a threshold, but the average values of all of a potential best fit's attributes might sufficiently fall within the average threshold of all of the actual target coating's attributes.

As an example, suppose a potential best fit match had the following attributes: a red chemical component value that was 1% of the target coating's red chemical component value and a blue chemical component value that was 0.1% of the target coating's blue chemical component value. Further suppose the threshold value was set to ±0.8%; meaning that if a potential best fit match's attributes were within ±0.8% of the target coating's attributes, then that potential best fit match would be included in the list of potentials/best fits. Taking the average of the potential best fit match's parameters would result in the following value: (1%+0.1%)/2=0.55%. In this example case, the 0.55% average is within the ±0.8% threshold range, so the potential best fit match would be included among the list of possible best fit matches. Of course, this is an example case only, and other techniques can be used to determine whether a potential best fit match should be included. Accordingly, one or more potential best fit matches can be selected.

Information about a particular best fit coating can also include information about an undercoat 440 that was used as a primer or initial coating on the asset. A confidence 445 metric can also be generated for the undercoat 440 as well.

Storage 450 can include a database 455 maintaining data on any number of coatings, including those selected as best fit coatings. The database 455 can be queried by the analysis engine 415 when attempting to identify best fit coatings for the target coating 410.

Along these lines, the database 455 (e.g., perhaps a cloud color database) can include a component for storing color options or selections by region and coating attributes for coatings used in different regions. For example, the database 455 can store data about coating components (e.g., formula/ingredients/parameters) and sub-components available to users in the eastern United States to coat a car of one particular year, make, and model, as well as similar options for other users in different parts of the United States (or in another region of the world) to coat the same car. The database 455 can keep an ongoing, continually updated database for what colors or versions thereof users are selecting in Europe, Australia, Eastern Asia, South America, and so forth. This data can help account for regional and personal selection differences selected by region to obtain the same overall look and color feel, and/or to account for regional preferences and manufacturer specifications that result in desired end color or overall color appearance/effect. Indeed, the database 455 can be a central repository used to track and maintain any number of coating attributes for any number of different coatings.

Additionally, the database 455 can include a color formula component. The color formula component can include various ingredients, amounts, recipes, and cost information for a given coating, as well as pricing and physical data for each individual sub-component, such as continually updated costs of particular physical types, costs of effect pigment (e.g., XIRALLIC, gonioapparent pigment, metallic flake, mica, pearlescent pigments, and the like), and costs of various color tints. Coatings with greater or lower relative pricing, such as those with multiple coating layers (e.g., tricoat, XIRALLIC) can be marked as such in the stored record. The color formula component can further include various physical or raw data measured for each coating sub-component, such as spectral, colorimetric, or other data for various tints, base coats, and effect pigments, including such data as measured from various combinations of such sub-components. The color formula component can also include predicted spectral or colorimetric data for given formulas where actual measurements have not yet been performed.

In some cases, the color formula component or attribute includes raw physical measurements or predicted measurements (also referred to herein as “secondary color data”), such as spectral, or other colorimetric measurements including but not limited to CIELab (i.e., L*a*b*) values, spectrophotometer reads, RGB, and gamma-RGB values, and/or XYZ tristimulus data, etc. for each coating, and each coating sub-component. In one or more additional or alternative implementations, the color formula component includes a mixture of raw physical measurements for a number of coatings and coating sub-components, and predicted physical measurements for other coatings or coating sub-components based on measurements taken from adjacent colors, such as colors in the same color space, but perhaps differing by one or more sub-components (e.g., different base), or differing by slight changes in hue, chroma, or toner ratio. As understood more fully herein, a coating manufacturer can predict colorimetric or spectral physical values for a color based on interpolating such values in next closest colors, or predicting such values when one of more sub-components of a color contains known physical measurements while other sub-components of the color contain unmeasured sub-components.

The database 455 can also include a component for correlating color with OEM color codes. In one instance, an operator, or automated update interface, can continually update the database 455 with both historical and recent updates to an asset manufacturer's coating codes and formulations used to coat a particular asset. Thus, the database 455 can store information such as the coating color and formulation used to coat a piece of heavy industrial equipment in the year 1970, as well as that used for a particular automobile of a certain make, and model as created in the year 2021, and so on.

The database 455 can also store various secondary indicia associated with each color and color formulation. For example, the database 455 can store barcode, QR code, and/or VIN (vehicle identification number) data associated with each color record, which may enable an end user to scan the corresponding code on the asset itself, and then enable the user to pull the record for the original color as stored by the database 455. Pulling the full record for the original color can indicate all components/ingredients/layers, and other parameters known about the original coating application. The database 455 can also serve as a central repository for the most recent updates of a coating manufacturer's colors and related physical data, such as formula, spectral, colorimetric, RGB, CIELAB, and/or XYZ tristimulus data and related conversion data, as well as image data, for each color and corresponding color sub-component used to make a particular coating.

The architecture 400 continues in FIG. 4B. As mentioned earlier, a user is able to select a specific best fit coating, which will be referred to as a test coating 460. The test coating 460 can be applied to an asset (e.g., asset 205 from FIG. 2). After the test coating 460 is applied and allowed to cure, it too can be analyzed using the techniques mentioned earlier. Consequently, a set of coating attributes 460A can be determined for the test coating 460.

Applying the test coating 460 to an asset is beneficial for a number of reasons. For instance, with the test coating 460 now applied to an asset, the test coating 460 can be analyzed and compared against the target coating 410 via an initial visual inspection or comparison. Additionally, the environmental conditions that are present during the application of the test coating 460 can be tracked and later analyzed to determine if those conditions warrant change in order to produce a better alignment.

In accordance with the disclosed principles, the coating attributes 460A of the test coating 460 and the coating attributes 420 of the target coating 410 can be transmitted over a network 465 to a server 470, which hosts a user interface 475. As will be described shortly, the user interface 475 is specially tailored to facilitate a comparison between the target coating 410 and the test coating 460 based on each coating's respective coating attributes. The user interface 475 is also structured to enable adjustments 480 to be executed to the test coating 460 in an effort to bring the test coating 460 into closer alignment with the target coating 410. The adjustments 480 and other data can be provided as feedback 485 to the remote facility 405. With that feedback 485, clients at the remote facility 405 can make corresponding adjustments to actual coating components in order to arrive at a coating that accurately matches the target coating. In some cases, machine learning can be used to automatically determine which adjustments to perform in order to align a test coating more closely with a target coating.

### Example User Interfaces

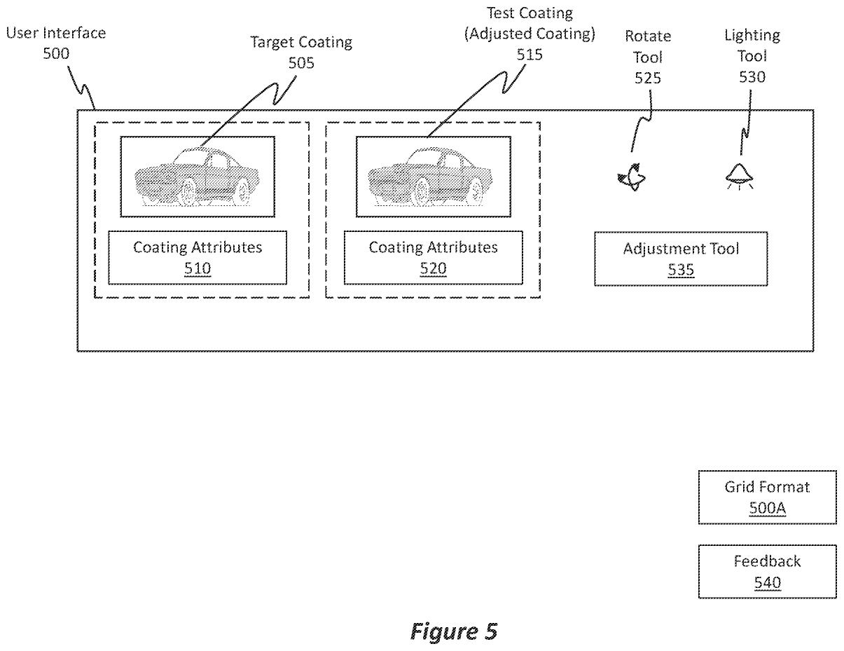

FIG. 5 illustrates an example user interface 500 that is representative of the user interface 475 from FIG. 4B. The user interface 500 can be structured to include a particular visual layout designed to help users adjust coating attributes of a test coating in an effort to align that test coating more closely with a target coating.

In FIG. 5, the user interface 500 is shown as displaying a user interface element representative of the target coating 505. Optionally, the target coating 505 can be rendered on a curved three-dimensional surface, such as perhaps a part of a vehicle. The user interface 500 is also configured to display the coating attributes 510 for the target coating 505.

The user interface 500 can have a grid format 500A, as shown by the dotted lines illustrated in the user interface. In some instances, the dotted lines may be visible while in other instances those lines can be hidden. In any event, one can observe how at least some of the information presented in the user interface 500 is arranged in a grid-like or box-like manner. For instance, the user interface 500 can display another user interface element at a location proximate to the target coating 505. To illustrate, notice how the user interface element representative of the test coating 515 is displayed proximately and in a grid-like manner near the target coating 505. The coating attributes 520 of the test coating 515 can also be displayed in the user interface 500.

Various tools can be provided by the user interface 500 to enable a user to modify views of the target coating 505 and/or the test coating 515. For instance, the user interface 500 can include a rotate tool 525 and a lighting tool 530.

That is, with this user interface 500, a user can manipulate 3D previews of the target coating 505 and/or the test coating 515, such as by manipulating the surfaces (e.g., perhaps a vehicle) to which those coatings are visually applied. As an example, using the rotate tool 525, a user can use a cursor or finger (in the case a touch screen is used) to touch the surface and to move it in different directions and to also zoom in or out. The surface can be moved in any direction such that different parts of the surface can be exposed. In this manner, the different displayed surfaces in the user interface can be movable to visually depict different angles of those surfaces.

With this user interface 500, a user can also manipulate various visual effects or features used to illuminate the visual rendering of the target coating 505 and the test coating 515. As an example, using the lighting tool 530, a user can modify a light source location for a programmatic light that is “shining” on the target coating 505 and/or the test coating 515. For instance, in one example case, a light source might be positioned at an angle at the front of the vehicle/surface. The light source can be moved to a different location, such as perhaps over the top of the vehicle, to the side of the vehicle, behind the vehicle, or any other location. The separation distance between the light source and the vehicle can also be modified, such as far separations or close separations. Accordingly, the location, placement, angle, and distance of the light source relative to the vehicle or surface can be modified. By modifying the light source in this manner, a user can observe how the coatings appear in different circumstances and situations.

The lighting tool 530 can also be used to add or remove one or more light sources. For instance, it may be the case that an existing light source is positioned in front of the vehicle/surface. Through use of the lighting tool 530, a user can add or delete one or more light sources. For example, a second light source can be added to the renderings. Perhaps this second light source is located behind the vehicle.

The lighting tool 530 can also be used to modify the type of light source that is used. That is, by selecting this option, the user can modify various attributes of a light source. For instance, the user can modify the color of the light source. The user can modify the brightness as well. The user can also modify the type of illumination, such as use of an incandescent light type of light bulb or an LED type of light. The user can also modify whether a flood lamp type of light is used (i.e. light that broadly illuminates a given area) or whether a spotlight type of light is used (i.e. light that is focused to illuminate a particular area).

When a user uses the rotate tool 525 and/or the lighting tool 530, the actions performed using those tools can be commonly performed to all or a selected number of the surfaces displayed in the user interface 500. For instance, using the rotate tool 525, a user can select the vehicle coated with the target coating 505 and rotate that vehicle. In sync with those rotations, the vehicle coated with the test coating 515 can also be moved based on the same input provided at the one vehicle. Similarly, actions performed using the lighting tool 530 can be commonly performed to those vehicles. Alternatively, such actions can be performed on only a selected one surface or vehicle without being performed on any other surface displayed in the user interface 500. Accordingly, actions can be performed in a synchronous or asynchronous manner.

In some cases, the test coating 515, which was originally selected as a result of being one of the “best fit” matches to the target coating 505, may still not be close enough to what the user perceives to be the target coating 505. As such, the invention provides techniques for enabling users and/or machine learning algorithms to apply adjustments to the test coating's attributes in an effort to modify the appearance of the test coating (producing a so-called “adjusted coating”) in order to bring that test coating into closer alignment with the target coating. Such adjustments or customizations can be implemented through an adjustment tool. Providing options to tailor or customize coatings ensures that the end user (e.g., body shop operator, customer, etc.) is confident in the final color selection.

To illustrate, the user interface 500 also includes an adjustment tool 535 that can be used to make adjustments to the test coating 515, to thereby generate an adjusted coating. Examples of such adjustments can include changes or modifications to the test coating 515′s chemistry composition, tint aspects, flake content, and so forth. FIG. 5 shows some example tools that can be included as parts of the adjustment tool 535. As used herein, “modified” or “adjusted” measurements or attributes refer to a scenario in which an original measurement or attribute has been changed (e.g., by a human user or via a machine learning algorithm) in an effort to align the measurement or attribute more closely with a standard or baseline measurement or attribute.

To illustrate, the adjustment tool 535 can include a toner tool, a light/dark tool (aka a tint tool, which is a tool that can be used to adjust a tint attribute of the test coating), a travel tool, a grain tool, and a flake tool, among others. These tools can have sliders or adjustment mechanisms that can be manipulated in order to adjust each of their respective coating attributes. Of course, other types of tools can be used to adjust these parameters as well (e.g., radial dials, numeric adjustments, bar charts, etc.).

For purposes of this specification and claims, the term “color travel” (aka “flop” or simply “travel”) refers to the change in reflectance of a color over a range of viewing angles of the same target/asset. High and low travel can be related to L* at different viewing angles.

These various tools can be used to adjust attributes of a particular coating, such as the test coating 515. One will appreciate how such adjustments, at least at this stage, are virtual adjustments in that a coating is not yet produced or synthesized. To clarify, by “virtual” it is meant that the computer system is generating a predicted coating based on the attributes specified using the user interface. Later, users can be provided with the option to actually produce a coating having the adjusted attributes. Providing tools to facilitate adjustments enables users to have confidence that the visually displayed coating will ultimately match the target coating of the asset.

In some cases, the chemistry component of a coating can also be adjusted via the adjustment tool 535. For example, suppose the red color pigment of the test coating 515 needs to be increased in order to better align the resulting adjusted coating with the target coating 505. The adjustment tool 535 can include a feature for adjusting the chemistry aspects, flake values, or other adjustable attributes of the test coating 515 in order to improve its match status. In some cases, adjusting the chemistry component can include adding or removing different compounds or amounts of compounds to a coating mixture.

Custom colors or other deviations/adjustments from known color records in the database 455 from FIG. 4A may be appropriate where aging or other discoloration in an asset renders finding an exact match in any system nearly impossible, or in other cases where a user simply prefers a particular color or color effect that has not yet been created.

In some cases, the adjustment tool 535 can also be used to provide instructions detailing how environmental conditions at the remote facility should be changed. As an example, even though the same exact coating might be used at different facilities, it is often the case that when the coating is applied, those applied coatings will appear to be slightly different. Such differences occur due to differences in environmental conditions, application techniques, curing conditions, or even tools used to apply the coatings. Stated differently, the differences or misalignments can occur because of differences in curing, reduction, or application methods. The adjustment tool 535 can be used to instruct users at the remote facilities to makes changes in environmental conditions, tools used, and/or application techniques followed when applying a coating.

Accordingly, the disclosed user interface 500 can be specially tailored to enable users to compare and contrast a test coating 515 against a target coating 505. If changes to the test coating 505 are desired, the user can use the various tools provided by the user interface 500 to make changes to the test coating 515, thereby producing an adjusted coating. Feedback 540 can then be provided to the remote facility. This feedback 540 is designed in an effort to help bring the test coating into closer alignment with the target coating. In some instances, the feedback 540 includes instructions on how to modify curing techniques, application techniques, or even environmental conditions. In some cases, the feedback 540 includes information detailing color misalignments. In some cases, the adjustment tool 535 can be used by a user to make virtual modifications to the test coating in order to discern how the test coating can be changed to bring it into closer alignment with the target coating (e.g., a sort of trial by error approach to matching colors). The modifications to the test coating can indicate that perhaps certain color components should be modified to achieve closer alignment. Accordingly, the adjustment tool 535 can be used to generate feedback output that can be provided to the remote facility.

### Example Methods

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

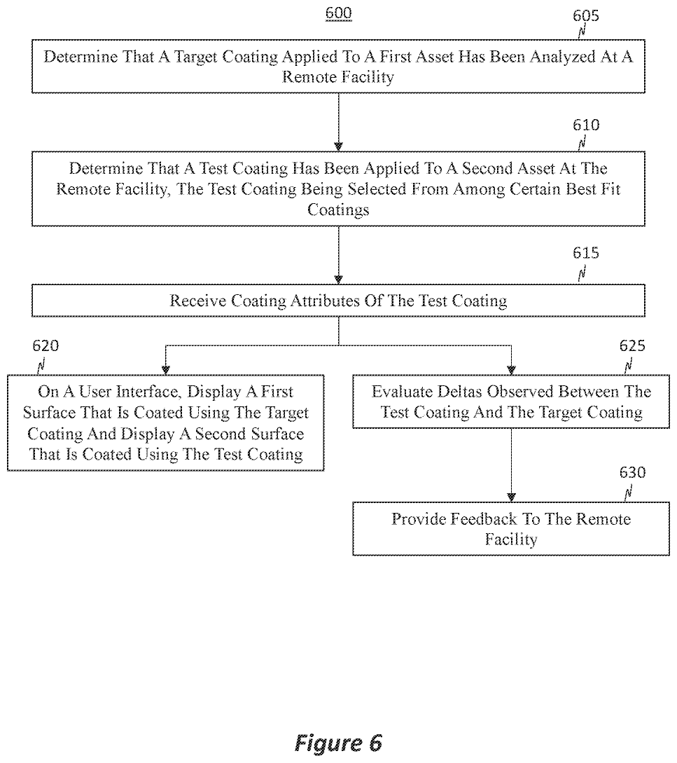

Attention will now be directed to FIG. 6, which illustrates a flowchart of an example method 600 for providing feedback to match coatings in accordance with a FMEA process. The method 600 can be performed within the architecture 400 of FIGS. 4A and 4B by a coating analysis system. Furthermore the computer system 300 can also be used to facilitate the method 600. The server 470 of FIG. 4B can also be used to facilitate method 600.

Initially, method 600 includes an act (act 605) of determining that a target coating (e.g., target coating 105 of FIG. 1) applied to a first asset (e.g., asset 100) has been analyzed at a remote facility (e.g., remote facility 405 of FIG. 4A). For example, the analysis can involve the use of the spectrophotometer 305 from FIG. 3 to identify the coating attributes of the target coating, such as (but not limited to), the environmental conditions of the remote facility, the CIELab color space values of the target coating, and so on. As a result of performing the analysis of the target coating, the system is able to identify one or more best fit coatings (e.g., best fit coatings 115 from FIG. 1) that are determined to match the target coating. To “match,” the coating attributes of the best fit coatings are within a specified threshold relative to the coating attributes of the target coating. The process of “determining” that the target coating has been applied can occur when coating attributes describing the target coating are received, such as perhaps at the server 470 in FIG. 4B.

Method 600 then includes an act (act 610) of determining that a test coating (e.g., test coating 460 from FIG. 4B) has been applied to a second asset at the remote facility. For instance, a user is able to review the various best fit coatings and then select one (or more) to operate as a “test coating.” This test coating can then be applied to an asset to determine its appearance after it cures. It is the hope that this test coating matches or aligns with the target coating, but that may not be the case. In this regard, the test coating was selected from among the best fit coatings and is selected for further analysis. The process of “determining” that the test coating has been applied can occur when coating attributes describing the test coating are received, such as perhaps at the server 470.

After the test coating has been applied to the second asset, there is an act (act 615) of receiving coating attributes (e.g., coating attributes 460A) of the test coating, such as perhaps at the server 470. The coating attributes can include a digital measurement of the test coating (e.g., perhaps CIELab color space values) and can further include data describing environmental conditions that occurred at a time when the test coating was applied to the second asset. Such conditions can include one or more of a temperature, humidity, elevation, barometric pressure, or even a time as to when the test coating was applied to the asset in the remote facility. The spectrophotometer 305 from FIG. 3 and the computer system 300 can be used to determine the coating attributes of the test coating. The coating attributes can be received at a server computer (e.g., server 470) system from the remote facility over a network.

Act 620 then involves displaying, on a user interface (e.g., user interface 500 of FIG. 5), a first surface that is coated using the target coating and displaying a second surface that is coated using the test coating. The user interface further displays the coating attributes of the test coating. With reference to FIG. 5, notice how the user interface 500 is displaying a first 3D rendering of a vehicle that has been coated with the target coating 505 and a second 3D rendering of a vehicle that has been coated with the test coating 515. These “vehicles” can be or can include the “surfaces” mentioned above.

In parallel with act 620, there is an act (act 625) of evaluating deltas observed between the test coating and the target coating. In some cases, the user interface can display, on the user interface, an adjustment tool (e.g., adjustment tool 535 in FIG. 5) that enables adjustment of the coating attributes of the test coating in order to facilitate the evaluation. As described previously, the adjustment tool 535 in FIG. 5 can be used to modify or adjust any number of attributes of the test coating 515, thereby producing or creating a so-called “adjusted coating.” For instance, the adjustment tool (during the evaluation) can be used to identify specific attributes that are different between the test coating and the target coating. Such attributes can include tint, light, flake content, etc. The adjustment tool can be used to help identify how the test coating differs relative to the target coating. The “evaluation” can involve comparing and contrasting the coating attributes of the test coating against those of the target coating, including performing a digital measurement comparison and evaluation. The evaluation can further include identifying qualitative adjustments that can be performed in an effort to more closely align the test coating with the target coating. In some cases, the evaluation is performed by comparing digital measurements. In some cases, the evaluation is performed via a visual comparison facilitated using the user interface. In some cases, the evaluation is performed using a machine learning algorithm or a lab technician. In some cases, the evaluation is performed via a trial by error process in which adjustments can be made to the displayed appearance of the test coating and those adjustments can be recorded to indicate how the test coating should be modified in order to more closely align with the target coating. In this sense, these adjustments can generate a “predicted” test coating or a “virtual” test coating.

In this regard, some implementations include receiving input using the adjustment tool. The input can be received relative to the digital measurement of the test coating. For instance, the test coating can operate as an initial baseline. The already-determined measurements or attributes for that test coating can then be modified in any manner, as described previously. The process of modifying the digital measurement or the coating attributes of the test coating results in generation of an adjusted coating that supposedly matches more closely with the target coating than how the test coating originally matched with the target coating. For example, it is desirable that the adjustments are designed or performed in an effort to produce a better (or more aligned) coating match with the target coating. The coating attributes of the adjusted coating can include predicted CIELab color space values that occur as a result of modifying adjustable values, such as perhaps chemistry components of a coating. Such adjustments can be performed during the evaluation in order to identify specifically how the two coatings differ relative to one another.

In some cases, the process of modifying the digital measurements or rather, modifying the coating components, of the test coating results in a “predicted” change to a chemistry or color component of the test coating. It is “predicted” because at this point, a new, real-world coating is not being produced or synthesized; instead, a computer-generated version is being created. Later, an actual coating having the adjust coating attributes can be produced.

As described earlier, the user interface can include any number of different tools as well. For example, the user interface can include options for adjusting lighting attributes of a light source that programmatically shines on the surface. Such options can be provided by the lighting tool 530 described in FIG. 5. Similarly, the user interface can include options for adjusting a visual appearance of the surfaces using the rotate tool 525. Such appearance changes can include rotations to the surface, translations of the surface, magnifications of the surface, or even changes to the shape and contours of the surface. As an example, at one instance, the user interface 500 of FIG. 5 might display a car. At a different instance, the user interface 500 might display a truck or van. Indeed, any shape or surface can be displayed by the user interface 500.

Act 630 then includes providing feedback to the remote facility, such as perhaps by conducting a FMEA process to identify misalignments and potentially even to resolve those misalignments via the adjustments mentioned earlier. The feedback details the observed differences or deltas. The feedback can also provide instructions on how to reduce the differences or deltas between to result in a closer alignment between the test coating and the target coating. By providing this feedback to the remote facility, operators or users at the remote facility can then concoct or generate a coating that is desirably more closely aligned with the target coating and/or can make modifications to the coating process based on the instructions provided with the feedback. The above process can be repeated any number of times until a satisfactory test coating is identified and produced. In some cases, the feedback can include an instruction to modify environmental conditions at the remote facility. In some cases, the feedback can include higher-level indications or instructions as opposed to fine grained indications. For example, an example of a fine grained feedback can include modifications to toner, light, travel, grain, and perhaps even flake. On the other hand, higher-level indications can include a feedback for indicating whether a match exists or does not exist. In some cases, the feedback can include indications that environmental conditions or application techniques used resulted in a match or un-match scenario.

The feedback can also include an indication as to whether the spray out is too wet in appearance. The feedback can also include an indication reflecting whether the spray out appears as it should relative to the target coating (e.g., the visual appearance characteristics). The feedback can reflect whether the spray out is too dark or perhaps too light. Based on the observed visual characteristics, the feedback can also include instructions on how to compensate or correct for observed differences or deltas. For instance, the instructions can include an instruction to modify application techniques of the coating (e.g., how is the coating sprayed, modifying the distance between the spray panel and the spray gun), an instruction to modify environmental conditions, an instruction to potentially modify color components of the coating, and even an instruction on application techniques used to apply the test coating to a spray panel.

In some cases, the qualitative feedback can indicate such things like “the red hue of the test coating is off by about 10% relative to the target coating” or similar language. That is, the feedback can not only identify a particular delta (e.g., red hue) but it can also identify an extent or amount by which the delta exists (e.g., 10%). A machine learning algorithm can generate an initial recommendation or suggestion or identified difference. That initial difference and recommendation can be provided to a lab technician who can then fine tune the difference and recommendation and then submit the difference and recommendation to the remote facility. The feedback can include curing feedback, application feedback, and/or color misalignment feedback. Indeed, any type of feedback can be provided, where that feedback is designed to help bring the test coating into closer alignment with the target feedback.

In an effort to further improve the user's experience, the system can further track which adjustments users make, either at a particular facility or across any number of facilities. For example, it may be the case that users at a particular facility all make the same or substantially the same adjustments using the user interface 500 of FIG. 5. The system is able to identify adjustments that have been made using the adjustment tool. The system can then store these adjustments as client preferences. Those client preferences can then be automatically or manually applied during a subsequent performance of the disclosed principles. For instance, a user can select an option to have his/her preferences automatically executed against a test coating.

Additionally, the system is able to aggregate a particular client's preferences with other clients' preferences, such as perhaps for a regional area. The system can also identify a frequency by which specific adjustments are commonly made across different clients. If the frequency is high enough, then the system can save those preferences and make them readily available as a selectable option for automatic execution against a test coating. In this manner, users will not have to repeatedly perform the same adjustments time after time. Instead, those adjustments can be performed automatically. In some cases, adjustments can be ranked based on frequency or popularity of use. Highly popular adjustments can then be provided via prompts for users to select and implement. Accordingly, an option can be displayed, where the option, when selected, automatically performs a saved adjustment using the adjustment tool.

The present invention can also be practiced with respect to more traditional facilities beyond just autobody shops, such as perhaps in the form of roofed buildings (e.g., to identify degradation/corrosion in or on buildings), with coil steel, metal roofs, and other structural components. The present invention (in particular principles of artificial intelligence) can further be used to identify a particular color, or even quality of a color match, such as may be used in automotive and residential coating matches. Still further, the present invention can be used in connection with style transfer, namely transferring a photo-realistic image of a style of one picture into another one. One will appreciate therefore that principles of the present invention can be applied not just to maintenance or refinishing, but also to general principles of quality assessment and assurance in a wide range of both industrial and personal use settings.

### Example Computer/Computer systems

Accordingly, the disclosed systems are beneficially able to provide unique user interfaces and operations designed to improve the coating selection process. To do so, the systems rely on computer systems that are configured in specific ways so as to achieve these benefits.

Returning to FIG. 3, this figure illustrates an example computer system 300 that may include and/or be used to perform any of the components or operations described herein. Computer system 300 may take various different forms. For example, computer system 300 may be embodied as a tablet, a desktop, a laptop, a mobile device, or a standalone device. Computer system 300 may also be a distributed system that includes one or more connected computing components/devices that are in communication with computer system 300.

In its most basic configuration, computer system 300 includes various different components. FIG. 3 shows that computer system 300 includes one or more processor(s) (e.g., 315A, 315B, 315C) (aka a “hardware processing unit”) and storage 320.

Regarding the processor(s), it will be appreciated that the functionality described herein can be performed, at least in part, by one or more hardware logic components (e.g., the processor(s) 315A, 315B, or 315C). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

References to an “engine” (e.g., ML engine 330) may be implemented as a specific processing unit (e.g., a dedicated processing unit as described earlier) configured to perform one or more specialized operations for the computer system 300. As used herein, the terms “executable module,” “executable component,” “component,” “module,” or “engine” can refer to hardware processing units or to software objects, routines, or methods that may be executed on computer system 300. The different components, modules, engines, and services described herein may be implemented as objects or processors that execute on computer system 300 (e.g. as separate threads).

Storage 320 may be physical system memory, which may be volatile, non-volatile, or some combination of the two. The term “memory” may also be used herein to refer to non-volatile mass storage such as physical storage media. If computer system 300 is distributed, the processing, memory, and/or storage capability may be distributed as well.

Storage 320 is shown as including executable instructions 325. The executable instructions 325 represent instructions that are executable by the processor(s) (or perhaps even the ML engine 330) of computer system 300 to perform the disclosed operations, such as those described in the various methods.

The disclosed embodiments may comprise or utilize a special-purpose or general-purpose computer including computer hardware, such as, for example, one or more processors and system memory (such as storage 320), as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Computer-readable media that carry computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 300 may also be connected (via a wired or wireless connection) to external sensors (e.g., one or more remote cameras) or devices via a network 335. For example, computer system 300 can communicate with any number devices (e.g., spectrophotometer 305) or cloud services to obtain or process data. In some cases, network 335 may itself be a cloud network. Furthermore, computer system 300 may also be connected through one or more wired or wireless networks 335 to remote/separate computer systems(s) that are configured to perform any of the processing described with regard to computer system 300.

A “network,” like network 335, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 300 will include one or more communication channels that are used to communicate with the network 335. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

In view of the foregoing, the present invention relates, for example and without being limited thereto, to the following aspects:

In a first aspect, a computer-implemented method, particularly according to any one of method eleven through sixteen, for providing feedback to match coatings can include determining that a target coating applied to a first asset has been analyzed at a remote facility, wherein, as a result of analyzing the target coating, one or more coatings that are determined to match the target coating are also identified; determining that a test coating has been applied to a second asset at the remote facility; receiving coating attributes of the test coating, which has been applied to a second asset at the remote facility, wherein the test coating was selected from among the one or more coatings, and the coating attributes include a digital measurement of the test coating and further include data describing environmental conditions that occurred at a time when the test coating was applied to the second asset; on a user interface, displaying a first surface that is coated using the target coating and displaying a second surface that is coated using the test coating, wherein the user interface further displays the coating attributes of the test coating; evaluating deltas observed between the test coating and the target coating; and providing feedback to the remote facility, wherein the feedback details the observed deltas and further provides instructions on how to reduce the deltas to result in a closer alignment between the test coating and the target coating.

In a second aspect of the computer-implemented method as recited in aspect one, the coating attributes of the test coating can include CIELab color space values.

In a third aspect of the computer-implemented method as recited in any of the preceding aspects one through two, the environmental conditions can include one or more of a temperature, humidity, elevation, barometric pressure, or a time when the test coating was applied to the second asset at the remote facility.

In a fourth aspect of the computer-implemented method as recited in any of the preceding aspects one through three, the instructions included in the feedback can include instructions to modify environmental conditions at the remote facility.

In a fifth aspect of the computer-implemented method as recited in any of the preceding aspects one through four, the user interface can further include options for adjusting lighting attributes of a light source that programmatically shines on the first surface.

In a sixth aspect of the computer-implemented method as recited in any of the preceding aspects one through five, the user interface can further include options for adjusting a visual appearance of the second surface.

In a seventh aspect of the computer-implemented method as recited in any of the preceding aspects one through six, the first surface and the second surface can be displayed in a grid format in the user interface.

In an eighth aspect of the computer-implemented method as recited in any of the preceding aspects one through seven, the method can further include identifying adjustments that have been made using an adjustment tool the test coating and storing said adjustments as client preferences.

In a ninth aspect of the computer-implemented method as recited in preceding aspect eight, the method can further include aggregating the client preferences with other client preferences and identifying a frequency by which specific adjustments are commonly made across different clients.

In a tenth aspect of the computer-implemented method as recited in any of the preceding aspects one through nine, the method can further include displaying an option that, when selected, automatically performs a saved adjustment using the adjustment tool.

In an eleventh aspect, another or additional configuration of a computer-implemented method, particularly using the computer system as recited in any one of aspects sixteen through twenty, for providing feedback to match coatings can include receiving coating attributes of a test coating previously applied to an asset, wherein the coating attributes include a digital measurement of the test coating and data describing environmental conditions that occurred at a time when the test coating was applied to the asset; on a user interface, displaying a first surface that is coated using a target coating and displaying a second surface that is coated using the test coating, wherein the user interface further displays the coating attributes of the test coating; evaluating deltas observed between the test coating and the target coating; and providing feedback to a remote facility, wherein the feedback details the observed deltas and further provides instructions on how to reduce the deltas to result in a closer alignment between the test coating and the target coating.

In a twelfth aspect of the computer-implemented method as recited preceding aspect eleven, the test coating and the target coating can be displayed in a grid format in the user interface.

In a thirteenth aspect of the computer-implemented method as recited in any of the preceding aspects eleven through twelve, the digital measurement can include CIELab color space values.

In a fourteenth aspect of the computer-implemented method as recited in any of the preceding aspects eleven through thirteen, the first surface in the user interface can be movable to visually depict different angles of the first surface.

In a fifteenth aspect of the computer-implemented method as recited in any of the preceding aspects eleven through fourteen, the instructions included in the feedback can include instructions on application techniques used to apply the test coating to a spray panel.

In a sixteenth aspect of the computer-implemented method as recited in any of the preceding aspects eleven through fifteen, the observed deltas included in the feedback can include a difference in one or more of a tint, lighting, or flake content between the test coating and the target coating.

In a seventeenth aspect, a computer system can be configured to provide feedback to match coatings, particularly using a method according any one of method aspect one through twenty-four, the computer system can include one or more processors; and one or more computer-readable hardware storage devices that store instructions that are executable by the one or more processors to cause the computer system to at least: receive coating attributes of a test coating previously applied to an asset, wherein the coating attributes include a digital measurement of the test coating and data describing environmental conditions that occurred at a time when the test coating was applied to the asset; on a user interface, display a first surface that is coated using a target coating and display a second surface that is coated using the test coating, wherein the user interface further displays the coating attributes of the test coating; evaluate deltas observed between the test coating and the target coating; and provide feedback to a remote facility, wherein the feedback details the observed deltas and further provides instructions on how to reduce the deltas to result in a closer alignment between the test coating and the target coating.

In an eighteenth aspect of the computer system as recited in preceding aspect seventeen, the coating attributes can include CIELab color space values.

In a nineteenth aspect of the computer system as recited in any of the preceding aspects seventeen through eighteen, the feedback can include an instruction to modify environmental conditions at the remote facility.

In a twentieth aspect of the computer system as recited in any of the preceding aspects seventeen through nineteen, the environmental conditions can include one or more of a temperature, humidity, elevation, barometric pressure, or a time when the test coating was applied to the asset at the remote facility.

In a twenty-first aspect of a method or computer system as recited in any one of aspects one through twenty, wherein the target coating is a coating that can be selected from a database of coatings.

In a twenty-second aspect of a method or computer system as recited in any one of aspects one through twenty-one, wherein each coating attribute comprises colorimeter data and/or reflectance data, of the respective coating, particularly obtained using a spectrometer.

In a twenty-third aspect of a method or computer system as recited in any one of aspects one through twenty-two, wherein the digital measurement can include a set of colorant and can associate with each colorant a probability that a particular colorant is present.

In a twenty-fourth aspect of a method or computer system as recited in any one of aspects one through twenty-three, wherein the environmental conditions can comprise data about the temperature, humidity, elevation, present during the application of the respective coating, equipment, such as coating equipment, tools, techniques, and/or the asset.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method for providing feedback to match coatings, comprising:
determining that a target coating applied to a first asset has been analyzed at a remote facility, wherein, as a result of analyzing the target coating, one or more coatings that are determined to match the target coating are also identified;
determining that a test coating has been applied to a second asset at the remote facility,
receiving coating attributes of the test coating, which has been applied to a second asset at the remote facility, wherein the test coating was selected from among the one or more coatings, and the coating attributes include a digital measurement of the test coating and further include data describing environmental conditions that occurred at a time when the test coating was applied to the second asset;
on a user interface, displaying a first surface that is coated using the target coating and displaying a second surface that is coated using the test coating, wherein the user interface further displays the coating attributes of the test coating;
evaluating deltas observed between the test coating and the target coating; and
providing feedback to the remote facility, wherein the feedback details the observed deltas and further provides instructions on how to reduce the deltas to result in a closer alignment between the test coating and the target coating.

2. The method of claim 1, wherein the coating attributes of the test coating include CIELab color space values.

3. The method of claim 1, wherein the environmental conditions include one or more of a temperature, humidity, elevation, barometric pressure, or a time when the test coating was applied to the second asset at the remote facility.

4. The method of claim 1, wherein the instructions included in the feedback include instructions to modify environmental conditions at the remote facility.

5. The method of claim 1, wherein the user interface further includes options for adjusting lighting attributes of a light source that programmatically shines on the first surface.

6. The method of claim 1, wherein the user interface further includes options for adjusting a visual appearance of the second surface.

7. The method of claim 1, wherein the first surface and the second surface are displayed in a grid format in the user interface.

8. The method of claim 1, wherein the method further includes identifying adjustments that have been made using an adjustment tool to the test coating and storing said adjustments as client preferences.

9. The method of claim 8, wherein the method further includes aggregating the client preferences with other client preferences and identifying a frequency by which specific adjustments are commonly made across different clients.

10. The method of claim 1, wherein the method further includes displaying an option that, when selected, automatically performs a saved adjustment using an adjustment tool.

11. A method for providing feedback to match coatings, comprising:
receiving coating attributes of a test coating previously applied to an asset, wherein the coating attributes include a digital measurement of the test coating and data describing environmental conditions that occurred at a time when the test coating was applied to the asset;
on a user interface, displaying a first surface that is coated using a target coating and displaying a second surface that is coated using the test coating, wherein the user interface further displays the coating attributes of the test coating;
evaluating deltas observed between the test coating and the target coating; and
providing feedback to a remote facility, wherein the feedback details the observed deltas and further provides instructions on how to reduce the deltas to result in a closer alignment between the test coating and the target coating.

12. The method of claim 11, wherein the test coating and the target coating are displayed in a grid format in the user interface.

13. The method of claim 11, wherein the digital measurement includes CIELab color space values.

14. The method of claim 11, wherein the first surface in the user interface is movable to visually depict different angles of the first surface.

15. The method of claim 11, wherein the instructions included in the feedback include instructions on application techniques used to apply the test coating to a spray panel.

16. The method of claim 11, wherein the observed deltas included in the feedback include a difference in one or more of a tint, lighting, or flake content between the test coating and the target coating.

17. A computer system configured to provide feedback to match coatings, said computer system comprising:
one or more processors; and
one or more computer-readable hardware storage devices that store instructions that are executable by the one or more processors to cause the computer system to at least:
receive coating attributes of a test coating previously applied to an asset, wherein the coating attributes include a digital measurement of the test coating and data describing environmental conditions that occurred at a time when the test coating was applied to the asset;
on a user interface, display a first surface that is coated using a target coating and display a second surface that is coated using the test coating, wherein the user interface further displays the coating attributes of the test coating;
evaluate deltas observed between the test coating and the target coating; and
provide feedback to a remote facility, wherein the feedback details the observed deltas and further provides instructions on how to reduce the deltas to result in a closer alignment between the test coating and the target coating.

18. The computer system of claim 17, wherein the coating attributes include CIELab color space values.

19. The computer system of claim 17, wherein the feedback includes an instruction to modify environmental conditions at the remote facility.

20. The computer system of claim 17, wherein the environmental conditions include one or more of a temperature, humidity, elevation, barometric pressure, or a time when the test coating was applied to the asset at the remote facility.
